(19) United States
(12) Patent Application Publication
(10) Pub. No.: US 2023/0166322 A1
(43) Pub. Date: Jun. 1, 2023

(54) MANUFACTURING METHOD AND MANUFACTURING SYSTEM

(71) Applicant: NHK Spring Co., Ltd., Yokohama-shi (JP)

(72) Inventors: Ryuichi Numakunai, Yokohama-shi (JP); Kaoru Nagasawa, Yokohama-shi (JP); Fumitaka Arai, Yokohama-shi (JP); Kiyoaki Tanabe, Yokohama-shi (JP); Yukiya Mori, Yokohama-shi (JP); Katsunori Suzuki, Yokohama-shi (JP); Akira Okubo, Yokohama-shi (JP)

(73) Assignee: NHK Spring Co., Ltd., Yokohama-shi (JP)

(21) Appl. No.: 17/696,265

(22) Filed: Mar. 16, 2022

Related U.S. Application Data
(60) Provisional application No. 63/284,468, filed on Nov. 30, 2021.

(51) Int. Cl. B21J 13/08; B21J 9/02; B21J 9/20

(52) U.S. Cl. CPC B21J 13/085; B21J 9/02; B21J 9/20

(57) ABSTRACT

A manufacturing method includes: conveying a target to a processing unit by using a conveying arm; conveying the target to a correction information acquiring unit provided in a position different from a position of the processing unit; acquiring position information relating to a position of the target conveyed to the correction information acquiring unit in a three-dimensional space; correcting a conveying position of the conveying arm to the processing unit based on the position information; and executing processing for the target conveyed to the corrected conveying position to manufacture a product.

This application claims the benefit of U.S. Provisional Application No. 63/284,468, filed on Nov. 30, 2021, the entire contents of which are incorporated herein by reference.

### BACKGROUND

The present disclosure relates to a manufacturing method and a manufacturing system.

In the related art, a method of conveying a base material serving as a forging target using a conveying arm, and subjecting the base material to forging processing has been known as a method used in manufacturing products by forging. The conveying arm holds the base material, and disposes the base material in a predetermined position in a forging machine by rotation and/or telescopic motion (for example, see Japanese Patent Application Laid-open No. 2016-159363).

### SUMMARY

An individual difference in forging position may occur according to the position to which the base material is conveyed. For example, when a hole is made in the base material, the center of the hole may be eccentric with respect to the set position. With a certain degree of eccentricity, the structure may be out of standard, and may not be shipped as a product.

There is a need for a manufacturing method and a manufacturing system capable of suppressing a shift of a processing position.

A manufacturing method according to one aspect of the present disclosure may include: conveying a target to a processing unit by using a conveying arm; conveying the target to a correction information acquiring unit provided in a position different from a position of the processing unit; acquiring position information relating to a position of the target conveyed to the correction information acquiring unit in a three-dimensional space; correcting a conveying position of the conveying arm to the processing unit based on the position information; and executing processing for the target conveyed to the corrected conveying position to manufacture a product.

A manufacturing system according to another aspect of the present disclosure may include: a conveying arm configured to convey a forging target; a forging processing unit configured to execute forging processing for the forging target conveyed by using the conveying arm; a correction information acquiring unit provided in a position different from a position of the forging processing unit, the correction information acquiring unit being configured to acquire position information relating to a position of the forging target in a three-dimensional space; and a correcting unit configured to correct a conveying position of the conveying arm to the forging processing unit based on the position information, wherein the conveying arm is configured to convey the forging target to the corrected conveying position.

### BRIEF DESCRIPTION OF THE DRAWINGS

FIG. 1 is a side view illustrating an example of a structure of a stabilizer manufactured in an embodiment;

FIG. 2 is a diagram illustrating a base material for manufacturing the stabilizer illustrated in FIG. 1 in a state before through holes are formed by forging;

FIG. 3 is a diagram illustrating a manufacturing system for manufacturing the stabilizer illustrated in FIG. 1;

FIG. 4 is a diagram illustrating a correction information acquiring apparatus illustrated in FIG. 3;

FIG. 5 is a flowchart illustrating a flow of forging processing executed by the manufacturing system;

FIG. 6 is a diagram (No. 1) illustrating correction information acquisition processing;

FIG. 7 is a diagram (No. 2) illustrating correction information acquisition processing;

FIG. 8 is a diagram (No. 3) illustrating correction information acquisition processing;

FIG. 9 is a diagram (No. 4) illustrating correction information acquisition processing;

FIG. 10 is a diagram illustrating eccentricity in the case where conveying position correction is executed;

FIG. 11 is a diagram illustrating eccentricity in the case where no conveying position correction is executed;

FIG. 12 is a diagram illustrating a deburring system according to a first modification;

FIG. 13 is a flowchart illustrating a flow of deburring processing executed by the deburring system according to the first modification;

FIG. 14 is a diagram illustrating a processing system according to a second modification;

FIG. 15 is a flowchart illustrating a flow of processing executed by the processing system according to the second modification; and

FIG. 16 is a diagram illustrating a processing system according to a third modification.

### DETAILED DESCRIPTION

An embodiment to carry out the present disclosure will now be described hereinafter with reference to the accompanying drawings. The drawings are schematic drawings, and the relation between the thickness and the width of each part and the ratio of thickness between the parts illustrated therein may be different from actual ones. The drawings may include parts having the relation and the ratio of sizes different between the drawings.

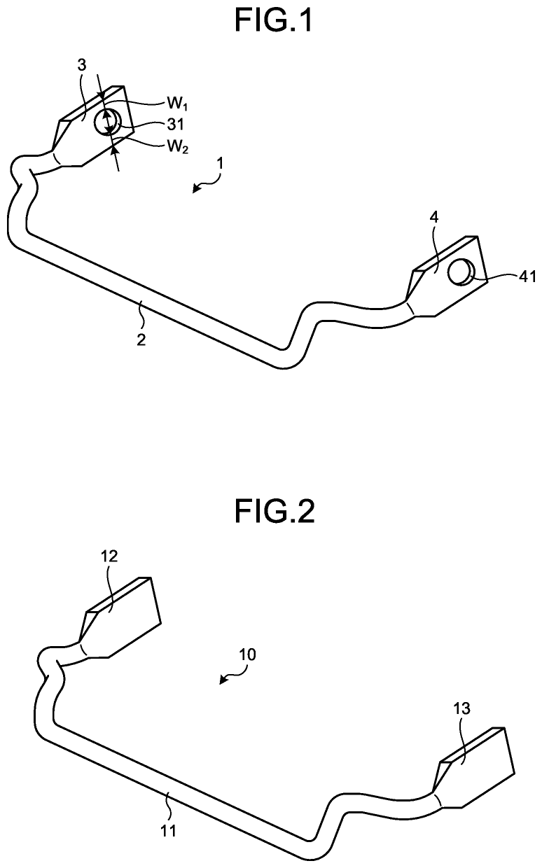

FIG. 1 is a side view illustrating an example of a structure of a stabilizer manufactured in an embodiment. A stabilizer 1 illustrated in FIG. 1 is formed of metal or various types of fibers (such as carbon fibers). The stabilizer 1 includes a main member part 2 including bent ends and a center portion extending linearly, a first end part 3 provided at one end of the main member part 2, and a second end part 4 provided at the other end of the main member part 2.

The main member part 2 extends in a columnar shape, such as a cylindrical shape. The main member part 2 may be solid or hollow.

The first end part 3 has a flat shape. The first end part 3 is provided with a through hole 31 extending in a thickness direction.

The second end part 4 has a flat shape. The second end part 4 is provided with a through hole 41 extending in a thickness direction.

For example, when the stabilizer 1 is provided on an automobile, the first end part 3 is connected to one of suspensions arranged on the left and the right of the automobile, and the second end part 4 is connected to the other of the suspensions. In the connection, the end parts are connected to the respective suspensions via the respective through holes.

The stabilizer 1 is manufactured by processing the base material. For example, a columnar base material is bent, thereafter each of both end portions of the base material is pressed into a flat shape, and each of the end portions is provided with a through hole.

FIG. 2 is a diagram illustrating a base material for manufacturing the stabilizer illustrated in FIG. 1 in a state before through holes are formed by forging. The stabilizer 1 is manufactured by, for example, forming through holes in the end portions of a base material 10. The base material 10 includes a main member part 11 including bent end portions, a first end part 12 provided at one end of the main member part 11, and a second end part 13 provided at the other end of the main member part 11. The base material 10 is manufactured by bending a material extending in a bar shape and thereafter pressing each of the end portions thereof into a flat shape.

In forging processing, the base material 10 is conveyed to a forging position, and a through hole is formed in each of the first end part 12 and the second end part 13.

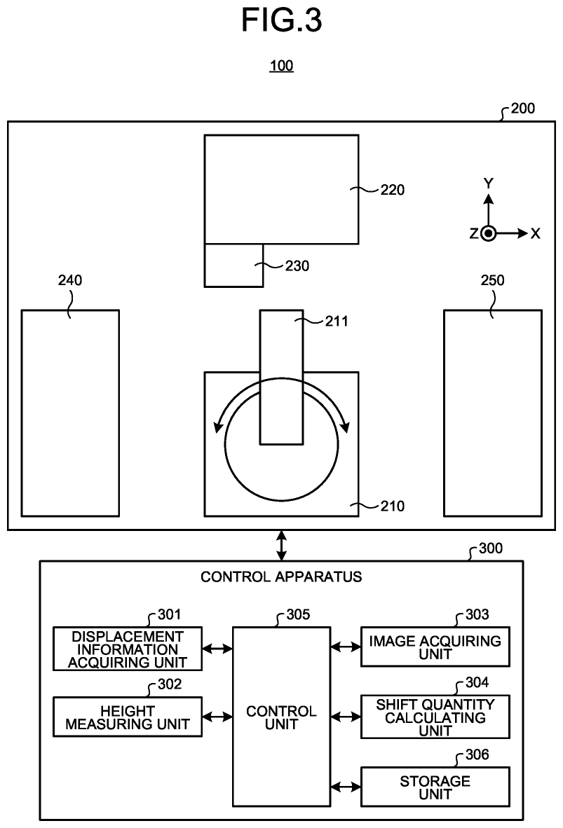

The following is an explanation of forging processing to form a through hole in each of both ends of the base material 10 described above with reference to FIG. 3 to FIG. 9. FIG. 3 is a diagram illustrating a manufacturing system for manufacturing the stabilizer illustrated in FIG. 1. A manufacturing system 100 is a manufacturing system including a manufacturing apparatus 200 executing forging processing for the base material 10, and a control apparatus 300 electrically controlling the manufacturing apparatus 200.

The manufacturing apparatus 200 includes a conveying unit 210 conveying the base material 10 and conveying the base material 10 (stabilizer 1), which is a forging processing target, a forging processing unit 220 subjecting the base material 10 to forging processing, a correction information acquiring unit 230 acquiring correction information to correct the position of the base material 10 conveyed by the conveying unit 210, a supplying unit 240 holding the base material 10 conveyed by the conveying unit 210 and supplying the base material 10 to be forged, and a discharge unit 250 receiving the base material 10 after forging processing and discharging the base material 10 to the outside. The manufacturing apparatus 200 illustrated in FIG. 3 corresponds to a layout drawing of the manufacturing apparatus 200 as viewed from above. In the layout drawing, a plane corresponding to a bottom plane (apparatus arrangement plane) is referred to as “XY plane” and a direction orthogonal to the XY plane is referred to as “Z direction”. Under these circumstances, an X direction, a Y direction, and a Z direction are mutually orthogonal. The Z direction is also referred to as “height direction”. The height direction is a vertical direction, that is, a direction parallel with a gravity direction.

The conveying unit 210 includes a conveying arm 211. The conveying arm 211 takes out the base material 10 from the supplying unit 240 under the control of the control apparatus 300, and conveys the base material 10 to the discharge unit 250 via the correction information acquiring unit 230 and the forging processing unit 220. The conveying arm 211 includes a plurality of arms and joints telescopically moving and rotating in a mode enabling conveyance of the base material 10 to positions in which processing of the base material 10 in the respective units is possible.

The forging processing unit 220 executes forging processing and descaling processing for the base material 10 conveyed with the conveying arm 211. The forging processing unit 220 includes a punch advancing and retreating in the Z direction. For this reason, in the forging processing unit 220, by drilling the base material 10, a through hole extending in the Z direction in the base material 10 is formed.

The correction information acquiring unit 230 acquires information to correct the position in the X direction, the Y direction, and the Z direction, and transmits the information to the control apparatus 300.

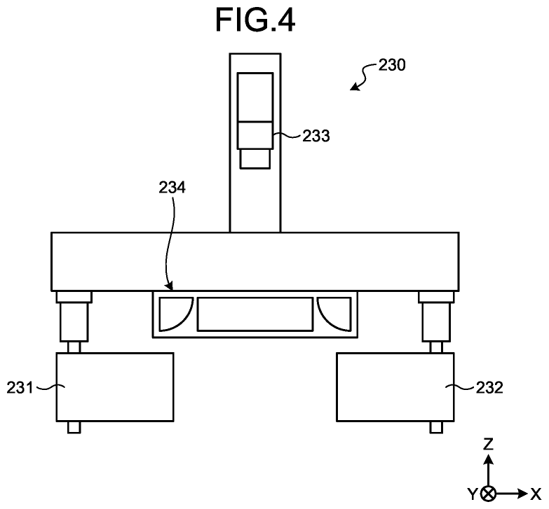

FIG. 4 is a diagram illustrating the correction information acquiring apparatus illustrated in FIG. 3. The correction information acquiring unit 230 includes a light projector unit 231, a light receiving unit 232, an imaging unit 233, and an illumination unit 234.

The light projector unit 231 emits light to detect the position of the base material 10 in the Z direction. The light projector unit 231 emits, for example, light of a wavelength band of an ultraviolet region and/or light (infrared light) of a wavelength band of an infrared region. The light projector unit 231 emits light in the X direction.

The light receiving unit 232 is provided in a position in which it can receive the light emitted by the light projector unit 231. The light receiving unit 232 is formed using a photodetector. The photodetector may be any photodetector capable of detecting the position of an object in the Z direction, and examples of the photodetector include a position sensitive detector (PSD), a charge coupled device (CCD) image sensor, and a complementary metal oxide semiconductor (CMOS) image sensor. The following explanation illustrates the case of using a CCD as the photodetector. When the light receiving unit 232 includes a CCD as the photodetector, the light receiving unit 232 forms a light receiving surface in which a plurality of pixels are arranged on a YZ plane, and outputs detected values (light receiving intensities) detected with the respective pixels to the control apparatus 300.

The light projector unit 231 and the light receiving unit 232 form a displacement sensor detecting the position of the end part of the base material 10 in the Z direction.

The imaging unit 233 images an end part (first end part 12 or second end part 13) of the conveyed base material 10. The imaging unit 233 includes an imaging optical system having an optical axis orthogonal to an XY plane, and images a plane parallel with the XY plane as an imaging surface. The imaging unit 233 outputs an image signal generated by imaging to the control apparatus 300. The imaging unit 233 is formed using an image sensor, such as the CCD and the CMOS.

The illumination unit 234 illuminates the imaging region of the imaging unit 233. The illumination unit 234 is formed using a light emitting diode (LED), a laser light source, and a lamp light source, such as a xenon lamp.

With reference to FIG. 3 again, the control apparatus 300 electrically controls operations of the manufacturing apparatus 200. The control apparatus 300 includes a displacement information acquiring unit 301, a height measuring unit 302, an image acquiring unit 303, a shift quantity calculating unit 304, a control unit 305, and a storage unit 306.

The displacement information acquiring unit 301 is connected to the light receiving unit 232 to be communicatable with the light receiving unit 232. The displacement information acquiring unit 301 outputs the received detected values to the control unit 305. The displacement information acquiring unit 301 is formed using a communication interface.

The height measuring unit 302 measures the height of the conveyed base material 10 on the basis of the detected values acquired by the displacement information acquiring unit 301. The height measuring unit 302 measures the position of the end part of the base material 10 on the basis of the receiving intensities of the respective pixels of the light receiving unit 232. For example, when the end part of the base material 10 is positioned between the light projector unit 231 and the light receiving unit 232, light from the light projector unit 231 is blocked, and the light receiving intensities of the corresponding pixels decrease. The height measuring unit 302 measures the height at which the end part of the base material 10 is positioned using the position in which the receiving intensities of the respective pixels are low as the end part existing position. The “height” herein corresponds to the shift quantity in the Z direction from a preset reference position.

The image acquiring unit 303 is connected to the imaging unit 233 to be communicatable with the imaging unit 233. The image acquiring unit 303 outputs the received image signal to the control unit 305. The image acquiring unit 303 is formed using a communication interface.

The shift quantity calculating unit 304 calculates shift of the end part of the base material 10 from a preset reference position as a shift quantity using the image signal acquired by the image acquiring unit 303. In the present embodiment, the shift quantity calculating unit 304 calculates shift quantities in the X direction, the Y direction, and the Z direction from the reference position. In this structure, for example, the shift quantity calculating unit 304 calculates shift quantities for the X direction and the Y direction using the image signal, and calculates a shift quantity for the Z direction on the basis of the height measured by the height measuring unit 302.

The control unit 305 controls the operation processing of each component of the control apparatus 300 and the manufacturing apparatus 200. For example, the control unit 305 determines whether the height measured by the height measuring unit 302 is a preset height, and adjusts the end part position of the base material 10 on the basis of a result of the determination. In addition, the control unit 305 controls the conveying position of the base material 10 with the conveying arm 211 on the basis of the shift quantities calculated by the shift quantity calculating unit 304.

Each of the height measuring unit 302, the shift quantity calculating unit 304, and the control unit 305 is formed using a processor, such as a central processing unit (CPU), and a processor of an arithmetic circuit of various types executing a specific function, such as an application specific integrated circuit (ASIC).

The storage unit 306 stores therein a computer program (such as a computer program to execute forging processing described later) to execute various operations with the control unit 305, and/or a threshold relating to position correction and the like. The storage unit 306 is formed using a volatile memory and/or a nonvolatile memory, or a combination thereof. For example, the storage unit 306 is formed using a random access memory (RAM) or a read only memory (ROM) or the like.

In addition, the control apparatus 300 may include an input unit receiving input of various signals relating to the operations of the control apparatus 300, and/or an output unit displaying an image and/or outputting sound and/or light. The input unit is formed using a keyboard, a mouse, a switch, and/or a touch panel or the like. The output unit is formed using a display, a speaker, and/or a light source or the like.

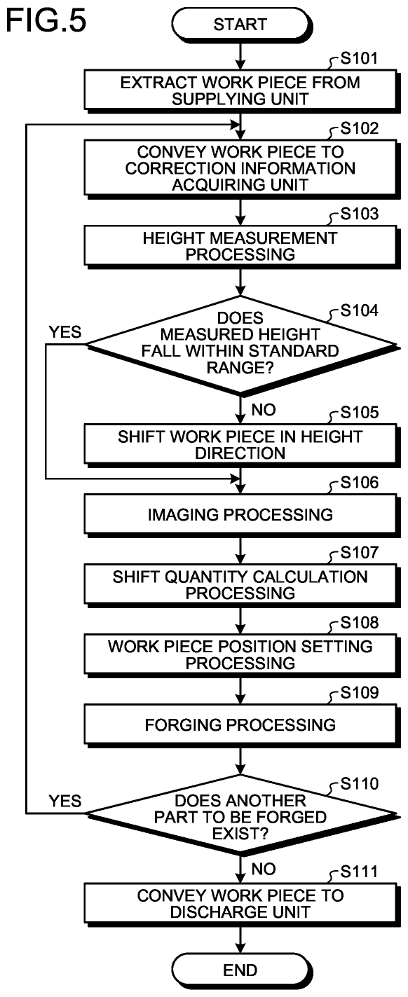

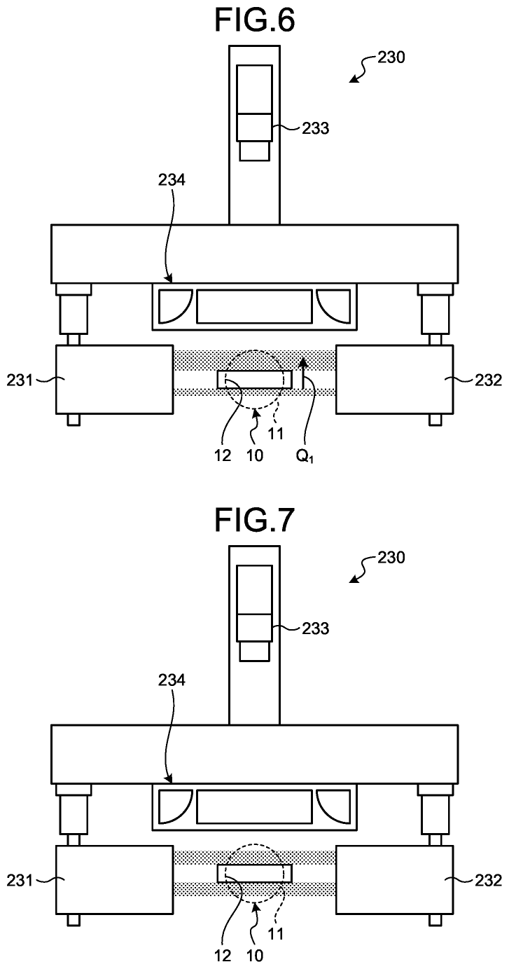

The following is an explanation of forging processing executed by the manufacturing system 100 with reference to FIG. 5 to FIG. 9. FIG. 5 is a flowchart illustrating a flow of forging processing executed by the manufacturing system. FIG. 6 to FIG. 9 are diagrams illustrating correction information acquisition processing.

First, a work piece is extracted from the supplying unit 240 with the conveying arm 211 (Step S101). The following explanation illustrates an example in which the work piece is the base material 10 having the shape illustrated in FIG. 2 and through holes 31 and 41 are formed by forging processing.

The conveying arm 211 conveys the work piece to the correction information acquiring unit 230 (Step S102). The conveying arm 211 expands or contracts the arm to a preset length and rotates the joint at a set angle to dispose the work piece in the correction information acquiring unit 230. In this operation, for example, as illustrated in FIG. 6, one end part (first end part 12 or second end part 13) of the base material 10 is disposed between the light projector unit 231 and the light receiving unit 232.

When the work piece is conveyed to the correction information acquiring unit 230, the height measuring unit 302 measures the height of the work piece (Step S103). The height measuring unit 302 receives the detected values from the displacement sensor (light receiving unit 232), and measures the position (height) of the work piece (end part of the base material 10) on the basis of the receiving intensities of the respective pixels. The height measuring unit 302 outputs the measured height to the control unit 305.

The control unit 305 determines whether the measured height falls within a preset reference range (Step S104). When the measured height falls within the reference range (Yes at Step S104), the control unit 305 proceeds to Step S106. By contrast, when the measured height is out of the reference range (No at Step S104), the control unit 305 proceeds to Step S105.

At Step S105, for example, the control unit 305 acquires a difference between a representative value of the measured height and a representative value of the reference range, and moves the work piece by the height corresponding to the difference. In this operation, a median, a maximum value, or a minimum value in the Z direction is used as the representative value. The conveying arm 211 moves the work piece in the Z direction by a distance corresponding to the difference. For example, the conveying arm 211 moves the base material 10 in an arrow Q₁ direction (Z direction) illustrated in FIG. 6. In this manner, the position of the first end part 12 is adjusted, as illustrated in FIG. 7. By the adjustment, the position in the optical axis direction is adjusted in the position of imaging with the imaging unit 233.

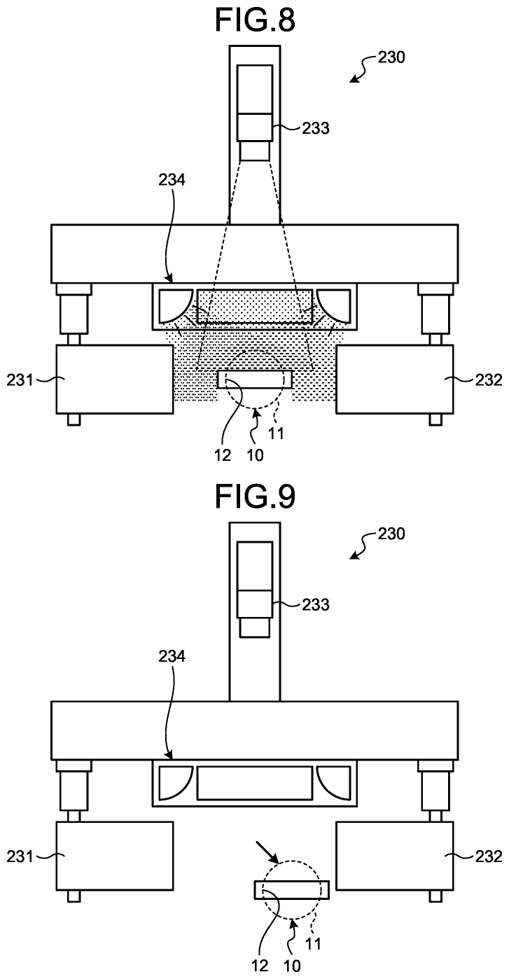

At Step S106, the control unit 305 causes the imaging unit 233 to execute imaging processing. The control unit 305 causes the illumination unit 234 to emit illumination light, and causes the imaging unit 233 to execute imaging processing (see FIG. 8). The imaging unit 233 images the work piece and outputs an image signal to the control apparatus 300 (image acquiring unit 303).

The shift quantity calculating unit 304 calculates shift quantities on the basis of the image signal acquired by the image acquiring unit 303 (Step S107). The shift quantity calculating unit 304 calculates the shift (shift quantities) of the end part position in the XY plane from an image of the end part of the base material 10. The shift quantity calculating unit 304 calculates the shift of the end part of the base material 10 in the image in each of the X direction and the Y direction from the preset position. The shift quantity calculating unit 304 detects the end part position in the image by contour extraction or the like, and calculates a difference between the end part position in the X direction and the reference position in the X direction as a shift in the X direction. The shift quantity calculating unit 304 also calculates a difference between the detected end part position in the Y direction and the reference position in the Y direction as a shift in the Y direction.

The shift quantity calculating unit 304 outputs the shift quantities in the X direction, the shift in the Y direction, and the shift in the Z direction to the control unit 305. The difference calculated at Step S104 is used as the shift in the Z direction. When it is determined at Step S104 that the reference range of the height is satisfied, the shift in the Z direction may be set to 0.

Thereafter, the control unit 305 corrects the position to which the conveying arm 211 conveys the work piece, on the basis of the shift quantities, and sets the work piece conveying position in the forging processing unit 220 (Step S108). The control unit 305 corrects the preset arm length and/or the rotation angle of the joint at the time when the work piece is conveyed to the forging processing unit 220 in accordance with the shift quantities. The conveying arm 211 conveys the work piece to the corrected conveying position under the control of the control unit 305.

When the work piece is moved from the correction information acquiring unit 230 with the conveying arm 211 (see FIG. 9) and conveyed to the forging processing unit 220, forging processing is executed by the forging processing unit 220 (Step S109). For example, in the forging processing unit 220, pierce trimming is executed for the end part of the base material 10 to form a through hole.

Thereafter, the control unit 305 determines whether any forging processing is required for another part of the work piece (Step S110). For example, the control unit 305 determines whether it is required to form a through hole in the other end part of the base material 10. When it is determined that forging processing is required for another part of the work piece (Yes at Step S110), the control unit 305 returns to Step S102, and executes forging processing for another part. By contrast, when it is determined that no forging processing is required for another part of the work piece (No at Step S110), the control unit 305 proceeds to Step S111.

At Step S111, the conveying arm 211 conveys the work piece subjected to the forging processing to the discharge unit 250 under the control of the control unit 305. As described above, forging processing is executed for a work piece.

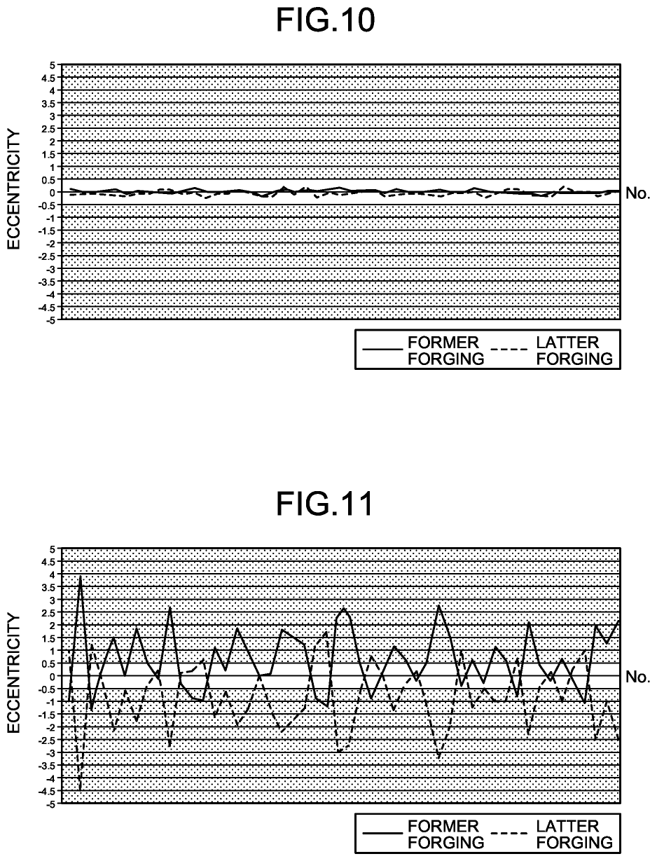

The following is an explanation of eccentricity of a through hole depending on presence/absence of conveying position correction with reference to FIG. 10. FIG. 10 is a diagram illustrating eccentricity in the case where conveying position correction is executed. FIG. 11 is a diagram illustrating eccentricity in the case where no conveying position correction is executed. Each of FIG. 10 and FIG. 11 illustrates a region exceeding the upper limit of eccentricity and a region having a value smaller than the lower limit value of eccentricity with hatching. Specifically, the hatched regions indicate that the position of the through hole formed in the end part is out of the standard of the stabilizer. This example illustrates the case where the value of ±0.5 mm falls within the standard. The waveform (former forging) illustrated with a solid line indicates eccentricity of the through hole in the end part for which forging processing was executed first for the base material, and the waveform (latter forging) illustrated with a broken line indicates eccentricity of the through hole in the end part for which forging processing was executed subsequently for the base material. The eccentricity is a length in a direction orthogonal to the longitudinal direction of the end part and the extending direction of the through hole, and a difference between lengths of the ends of the through hole in the position extending through the center of the through hole is set as the degree of eccentricity. For example, a difference between lengths W₁ and W₂ illustrated in FIG. 1 is defined as eccentricity. When the through hole is formed, for example, in the center of the end part, the eccentricity is 0.

When the waveform of the former forging is compared with the waveform of the latter forging, the waveforms are reverse to each other with respect to a boundary around the region in which the eccentricity is 0. It is considered that this is caused by the rotation of the conveying arm 211.

When the waveforms illustrated in FIG. 10 are compared with the waveforms illustrated in FIG. 11, the waveforms (see FIG. 10) in the case where the forging position is corrected have degrees of eccentricity falling within the standard. By contrast, with the waveforms (see FIG. 11) in the case where the forging position is not corrected, the degrees of eccentricity of many products are out of the standard.

In addition, the process capability index was calculated for each of conditions. Specifically, Cpk was calculated as the process capability index. Cpk is calculated by the following expression (1).

Cpk=(1−K)Cp

Cp=(U_{CL}-L_{CL})/6σ

K=(|(U_{CL}+L_{CL})/2−∞|)/((U_{CL}−L_{CL})/2) (1)

U_{CL} is an upper limit standard value, L_{CL} is a lower limit standard value, and μ is an average value.

A result that Cpk calculated on the basis of the eccentricity illustrated in FIG. 10 was larger than 1.49 was obtained. In addition, Cpk calculated on the basis of the eccentric illustrated in FIG. 11 was substantially 0. In view of the result, it can be said that executing position correction achieves high process capability and a reduction in fluctuations in hole position between products.

According to the embodiment described above, the forging processing position with the conveying arm is corrected on the basis of information acquired in another conveying position in advance. This structure enables suppression of a shift of the processing position when the forging processing is executed. In addition, the present embodiment enables suppression of a shift in forging position in the work piece and a shift in forging position between individual work pieces by executing position correction for each of forged parts of the work piece and each of the work piece.

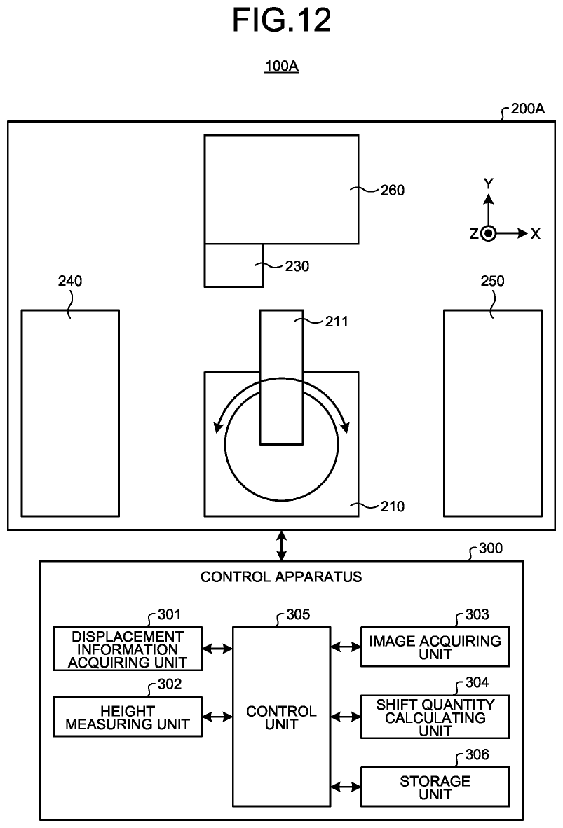

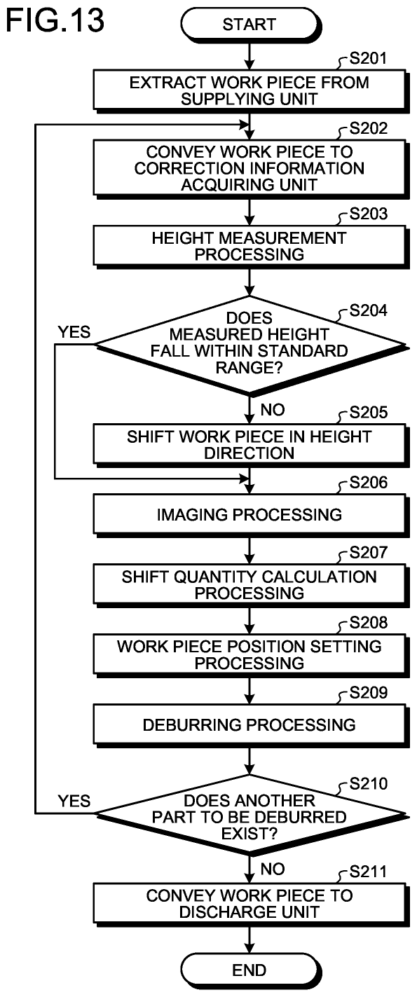

The following is an explanation of a first modification of the present embodiment with reference to FIG. 12 and FIG. 13. FIG. 12 is a diagram illustrating a processing system according to the first modification. A deburring system 100A illustrated in FIG. 12 includes a deburring processing apparatus 200A executing deburring processing for the base material, and the control apparatus 300 electrically controlling the deburring processing apparatus 200A. Constituent elements having the same functions as those of the forging processing system 100 according to the embodiment are denoted by the same reference numerals.

The deburring processing apparatus 200A includes the conveying unit 210 conveying the base material and conveying the forged base material serving as a deburring target, a deburring processing unit 260 executing deburring processing for the base material, the correction information acquiring unit 230 acquiring correction information to correct the position of the base material conveyed by the conveying unit 210, the supplying unit 240 holding the base material conveyed by the conveying unit 210 and supplying the base material to be deburred, and the discharge unit 250 base material after deburring processing and discharging the base material to the outside. The deburring processing apparatus 200A corresponds to a layout drawing of the deburring processing apparatus 200A as viewed from above. In the layout drawing, a plane corresponding to a bottom plane (apparatus arrangement plane) is referred to as “XY plane” and a direction orthogonal to the XY plane is referred to as “Z direction”.

The deburring processing unit 260 executes deburring processing for the base material conveyed by the conveying arm 211. The deburring processing unit 260 includes a die pressing member advancing and retreating in the Z direction. In the deburring processing unit 260, the die pressing member presses the base material in the Z direction to remove burrs. The deburring processing unit 260 may have a structure of executing deburring with a drill, or a structure of executing deburring using a polishing member, such as a flap wheel.

The control apparatus 300 electrically controls operations of the deburring processing apparatus 200A. In the same manner as the embodiment, the control apparatus 300 includes the displacement information acquiring unit 301, the height measuring unit 302, the image acquiring unit 303, the shift quantity calculating unit 304, the control unit 305, and the storage unit 306. The control apparatus 300 controls operations of the deburring processing apparatus 200A to execute deburring processing for the base material.

The following is an explanation of processing executed by the deburring system 100A with reference to FIG. 13. FIG. 13 is a flowchart illustrating a flow of deburring processing executed by the deburring system according to the first modification.

In deburring processing, in the same manner as Step S101 according to the embodiment, a work piece is extracted from the supplying unit 240 under the control of the control apparatus 300 (Step S201). The following is an explanation of an example in which deburring is executed for the work piece being the base material in which through holes 31 and 41 (see FIG. 1) are formed by forging processing.

Thereafter, in the same manner as Steps S102 to S108 of the embodiment, the control apparatus 300 conveys the work piece to the correction information acquiring unit 230 to execute measurement and determination of the height of the work piece, calculation of the shift quantities on the basis of the image signal, and setting of the conveying position for the work piece (Steps S202 to S208).

When the work piece is moved from the correction information acquiring unit 230 by the conveying arm 211 and conveyed to the deburring processing unit 260, deburring processing is executed in the deburring processing unit 260 (Step S209).

Thereafter, the control unit 305 determines whether any deburring processing is required for another part of the work piece (Step S210). For example, the control unit 305 determines whether deburring processing is required for the other end part of the base material 10. When it is determined that deburring processing is required for another part of the work piece (Yes at Step S210), the control unit 305 returns to Step S202, and executes deburring processing for another part. By contrast, when it is determined that no deburring processing is required for another part of the work piece (No at Step S210), the control unit 305 proceeds to Step S211.

At Step S211, the conveying arm 211 conveys the work piece subjected to the deburring processing to the discharge unit 250 under the control of the control unit 305. As described above, deburring processing is executed for a work piece.

According to the first modification described above, the deburring processing position with the conveying arm is corrected on the basis of information acquired in another conveying position in advance. This structure enables suppression of a shift of the processing position when deburring processing is executed. In addition, according to the first modification, position correction is executed for each of processed parts of the work piece and for each work piece. This structure enables suppression of a shift of the deburring processing position in the work piece and/or a shift of the deburring processing position between the individual work pieces.

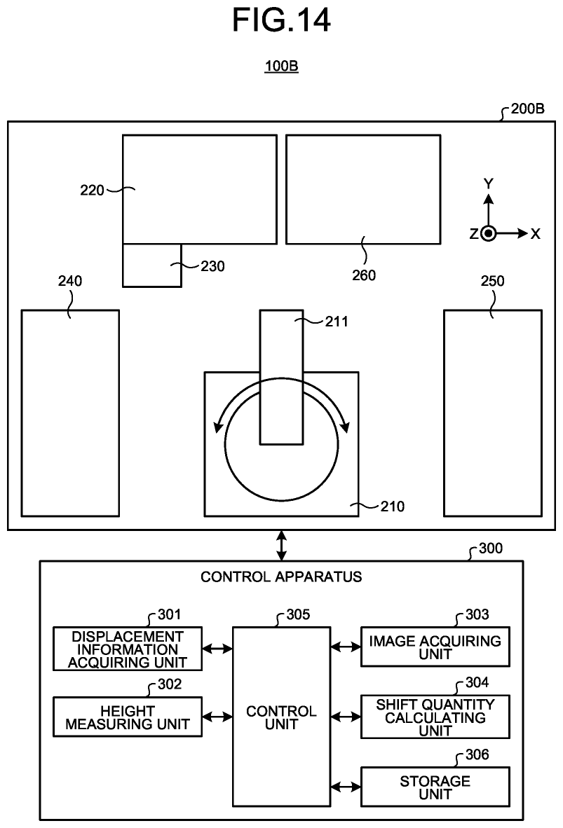

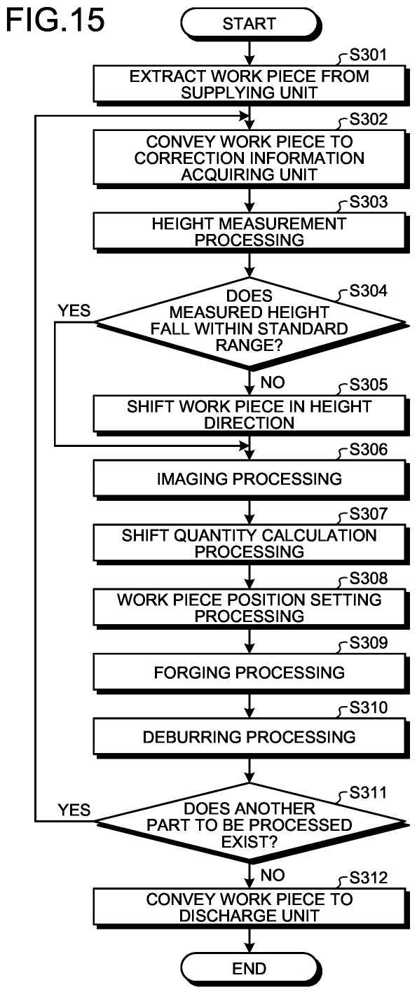

The following is an explanation of a second modification of the present embodiment with reference to FIG. 14 and FIG. 15. FIG. 14 is a diagram illustrating a processing system according to the second modification. A processing system 100B illustrated in FIG. 14 includes a processing apparatus 200B executing forging processing and deburring processing for the base material, and the control apparatus 300 electrically controlling the processing apparatus 200B. Constituent elements having the same functions as those of the forging processing system 100 and/or the deburring system 100A according to the embodiment are denoted by the same reference numerals.

The processing apparatus 200B includes the conveying unit 210 conveying the base material, the forging processing unit 220 executing forging processing for the base material, the deburring processing unit 260 executing deburring processing for the base material, the correction information acquiring unit 230 acquiring correction information to correct the position of the base material conveyed by the conveying unit 210, the supplying unit 240 holding the base material conveyed by the conveying unit 210 and supplying the base material to be processed, and the discharge unit 250 receiving the base material after deburring processing and discharging the base material to the outside. The processing apparatus 200B corresponds to a layout drawing of the processing apparatus 200B as viewed from above. In the layout drawing, a plane corresponding to a bottom plane (apparatus arrangement plane) is referred to as “XY plane” and a direction orthogonal to the XY plane is referred to as “Z direction”. In the processing apparatus 200B, an example explained is an example in which the correction information acquiring unit 230 is provided in the forging processing unit 220, but the correction information acquiring unit 230 may be installed in a place other than the forging processing unit 220, such as the deburring processing unit 260.

The control apparatus 300 electrically controls operations of the processing apparatus 200B. In the same manner as the embodiment, the control apparatus 300 includes the displacement information acquiring unit 301, the height measuring unit 302, the image acquiring unit 303, the shift quantity calculating unit 304, the control unit 305, and the storage unit 306. The control apparatus 300 controls operations of the processing apparatus 200B to execute forging processing and/or deburring processing for the base material.

The following is an explanation of processing executed by the processing system 100B with reference to FIG. 15. FIG. 15 is a flowchart illustrating a flow of processing executed by the processing system according to the second modification.

In deburring processing, in the same manner as Step S101 according to the embodiment, a work piece is extracted from the supplying unit 240 under the control of the control apparatus 300 (Step S301). The following is an explanation of an example in which the work piece extracted from the supplying unit 240 is the base material (for example, see FIG. 2) to be subjected to forging processing and deburring processing.

Thereafter, in the same manner as Steps S102 to S108 of the embodiment, the control apparatus 300 conveys the work piece to the correction information acquiring unit 230 to execute measurement and determination of the height of the work piece, calculation of the shift quantities on the basis of the image signal, and setting of the conveying position for the work piece (Steps S302 to S308). By the setting of the conveying position for the work piece, the conveying position in the forging processing unit 220 and the conveying position in the deburring processing unit 260 are set.

When the work piece is moved from the correction information acquiring unit 230 by the conveying arm 211 and conveyed to the conveying position of the forging processing unit 220, forging processing is executed in the forging processing unit 220 (Step S309).

Thereafter, when the work piece is moved from the forging processing unit 220 by the conveying arm 211 and conveyed to the conveying position of the deburring processing unit 260, deburring processing is executed in the deburring processing unit 260 (Step S310).

Thereafter, the control unit 305 determines whether any processing (forging processing and deburring processing) is required for another part of the work piece (Step S311). For example, the control unit 305 determines whether processing is required for the other end part of the base material 10. When it is determined that processing is required for another part of the work piece (Yes at Step S311), the control unit 305 returns to Step S302, and executes processing for another part. By contrast, when it is determined that no processing is required for another part of the work piece (No at Step S311), the control unit 305 proceeds to Step S312.

At Step S312, the conveying arm 211 conveys the work piece subjected to the deburring processing to the discharge unit 250 under the control of the control unit 305. As described above, forging processing and deburring processing are executed for a work piece.

According to the second modification described above, each of the forging processing position and the deburring processing position with the conveying arm is set on the basis of information acquired in another conveying position in advance. This structure enables suppression of a shift of the processing position when each of the forging processing and the deburring processing is executed. In addition, according to the second modification, the conveying positions are set on the basis of common correction information for processes in mutually different positions. This structure enables setting of the conveying positions enabling proper processing while suppressing the processing load.

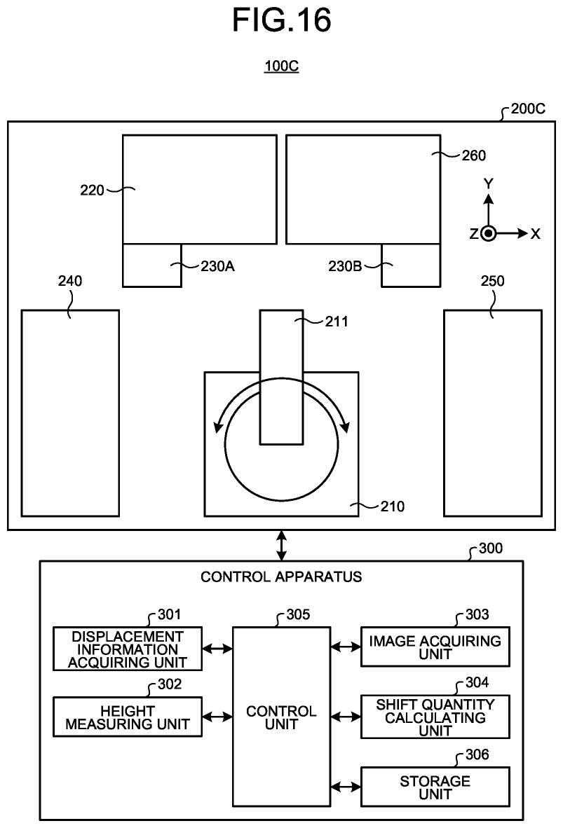

The following is an explanation of a third modification of the present embodiment with reference to FIG. 16. FIG. 16 is a diagram illustrating a processing system according to the third modification. A processing system 100C illustrated in FIG. 16 includes a processing apparatus 200C executing forging processing and deburring processing for the base material, and the control apparatus 300 electrically controlling the processing apparatus 200C. Constituent elements having the same functions as those of the forging processing system 100, the deburring system 100A, and/or the processing system 100B according to the embodiment are denoted by the same reference numerals.

The processing apparatus 200C includes the conveying unit 210 conveying the base material, the forging processing unit 220 executing forging processing for the base material, the deburring processing unit 260 executing deburring processing for the base material, a first correction information acquiring unit 230A acquiring correction information to correct the position of the base material conveyed by the conveying unit 210 to the forging processing unit 220, a second correction information acquiring unit 230B acquiring correction information to correct the position of the base material conveyed by the conveying unit 210 to the deburring processing unit 260, the supplying unit 240 holding the base material conveyed by the conveying unit 210 and supplying the base material to be processed, and the discharge unit 250 receiving the base material after deburring processing and discharging the base material to the outside. The processing apparatus 200C corresponds to a layout drawing of the processing apparatus 200C as viewed from above. In the layout drawing, a plane corresponding to a bottom plane (apparatus arrangement plane) is referred to as “XY plane” and a direction orthogonal to the XY plane is referred to as “Z direction”.

The control apparatus 300 electrically controls operations of the processing apparatus 200C. In the same manner as the embodiment, the control apparatus 300 includes the displacement information acquiring unit 301, the height measuring unit 302, the image acquiring unit 303, the shift quantity calculating unit 304, the control unit 305, and the storage unit 306. The control apparatus 300 controls operations of the processing apparatus 200C to execute forging processing and/or deburring processing for the base material.

In the third modification, each of the first correction information acquiring unit 230A and the second correction information acquiring unit 230B in the processing apparatus 200C acquires information to correct the conveying position, and each of the conveying positions is set in the control apparatus 300.

According to the third modification explained above, each of the forging processing position and the deburring processing position with the conveying arm is set on the basis of information acquired in another conveying position in advance. This structure enables suppression of a shift of the processing position when each of the forging processing and the deburring processing is executed. In addition, according to the third modification, the conveying positions are set on the basis of pieces of correction information acquired individually for respective processes in mutually different positions. This structure enables securer setting of the conveying positions enabling proper processing.

In the embodiment and the modifications, the information to correct the shift in each of the X direction, the Y direction, and the Z direction is acquired with the displacement sensor (light projector unit 231 and light receiving unit 232) and the imaging unit 233. However, as long as information to correct the shift in each of the directions can be acquired, the correction information acquiring unit 230 may be formed of only the displacement sensor, only the imaging unit, or a sensor detecting the position in a three-dimensional manner. For example, the temperature of the base material 10 may be detected, and the position in the correction information acquiring unit may be detected on the basis of the temperature distribution. In this case, the shift quantity calculating unit 304 calculates the shift between the position detected on the basis of the temperature distribution and the predetermined original position in which the base material 10 is to be disposed, and determines the shift quantities.

The embodiment and the modifications described above illustrates the example of correcting the conveying position of the conveying arm 211 with respect to shifts in three directions, that is, the X direction, the Y direction, and the Z direction, but the rotation angle around the axis of each of the directions may be detected to be reflected on the conveying position. In this case, for example, the rotation angle around the axis in the X direction is detected on the basis of the size of the end part in the image, and the rotation angle is reflected on the rotation angle of the joint.

The embodiment of the present disclosure has been described above, but the present disclosure is not limited only to the embodiment described above. For example, the present disclosure is applicable to products manufactured by executing forging processing or deburring processing.

As described above, the present disclosure may include various embodiments and the like that are not described herein, and various changes in design and the like are possible within the range not departing from the technical idea specified in the specification.

As described above, the manufacturing method and the manufacturing system according to the present disclosure may suppress a shift of the processing position.

What is claimed is:

1. A manufacturing method comprising:
conveying a target to a processing unit by using a conveying arm;
conveying the target to a correction information acquiring unit provided in a position different from a position of the processing unit;
acquiring position information relating to a position of the target conveyed to the correction information acquiring unit in a three-dimensional space;
correcting a conveying position of the conveying arm to the processing unit based on the position information; and
executing processing for the target conveyed to the corrected conveying position to manufacture a product.

2. The manufacturing method according to claim 1, wherein the correcting includes:
calculating shifts in mutually orthogonal three directions based on the position information; and
correcting the conveying position based on the shifts.

3. The manufacturing method according to claim 2, wherein the correcting includes:
calculating a shift in one direction in the mutually orthogonal three directions;
calculating a shift on a plane formed of the other two directions; and
correcting the conveying position based on the shifts.

4. The manufacturing method according to claim 3, wherein the correcting includes:
calculating a shift in a height direction;
calculating a shift on a plane orthogonal to the height direction; and
correcting the conveying position based on the shifts.

5. The manufacturing method according to claim 1, wherein the processing includes executing forging processing for the target conveyed to the conveying position.

6. The manufacturing method according to claim 5, wherein the forging processing includes drilling the target to form a through hole.

7. The manufacturing method according to claim 1, wherein the processing includes executing deburring processing for the target conveyed to the conveying position.

8. The manufacturing method according to claim 1, wherein
the processing includes executing:
forging processing for the target conveyed to the conveying position; and
deburring processing for the target conveyed to the conveying position, and
the correcting includes correcting the conveying positions for the forging processing and the deburring processing based on the acquired position information.

9. The manufacturing method according to claim 1, wherein
the processing includes executing:
forging processing for the target conveyed to the conveying position, and
deburring processing for the target conveyed to the conveying position,
the acquiring includes acquiring the position information for each of the forging processing and the deburring processing, and
the correcting includes correcting the conveying positions based on the respective pieces of position information.

10. A manufacturing system comprising:
a conveying arm configured to convey a forging target;
a forging processing unit configured to execute forging processing for the forging target conveyed by using the conveying arm;
a correction information acquiring unit provided in a position different from a position of the forging processing unit, the correction information acquiring unit being configured to acquire position information relating to a position of the forging target in a three-dimensional space; and
a correcting unit configured to correct a conveying position of the conveying arm to the forging processing unit based on the position information, wherein
the conveying arm is configured to convey the forging target to the corrected conveying position.
